(19) United States
(12) Patent Application Publication
(10) Pub. No.: US 2022/0297360 A1
(43) Pub. Date: Sep. 22, 2022

(54) TRAILING ARM MANUFACTURING METHOD

(71) Applicant: HONDA MOTOR CO., LTD., Tokyo (JP)

(72) Inventor: Shinsuke Shimoda, Wako-shi (JP)

(21) Appl. No.: 17/678,061

(22) Filed: Feb. 23, 2022

(30) Foreign Application Priority Data
Mar. 22, 2021 (JP) 2021-047592

(51) Int. Cl. B29C 45/14; B60G 7/00; B60G 7/02

(52) U.S. Cl. CPC B29C 45/1418; B60G 7/001; B60G 7/02; B60G 2206/82; B60G 2206/81; B60G 2204/41; B29K 2705/00

(57) ABSTRACT

A trailing arm manufacturing method includes: preparing a metallic inner plate and a resinous plate member composed of at least two components; heat-crimping the inner plate while sandwiching the inner plate with the plate members in a state in which the inner plate is disposed between the plate members by using a pair of left and right molding dies including a rib molding portion for injection-molding a rib portion having a plurality of ribs; and injection-molding the rib portion on the plate member during the heat-crimping or after the heat-crimping.

### CROSS-REFERENCE TO RELATED APPLICATION

Priority is claimed on Japanese Patent Application No. 2021-047592, filed Mar. 22, 2021, the content of which is incorporated herein by reference.

### BACKGROUND OF THE INVENTION

### Field of the Invention

The present invention relates to a trailing arm manufacturing method.

### Description of Related Art

Conventionally, a manufacturing method for manufacturing a hollow component from two resinous half-split bodies using a molding die is known (for example, Japanese Unexamined Patent Application, First Publication No. H5-42604).

One half-split body is integrally provided with a leg portion extending from a body portion toward the other half-split body to engage therewith, and the one half-split body and the other half-split body are joined in the molding die.

### SUMMARY OF THE INVENTION

In the above manufacturing method, for example, when the leg portion of one half-split body is made of a material different from that of the body portion, a mold for molding the leg portion on the body portion by injection-molding or the like and man-hours thereof are required.

An aspect of the present invention is to provide a method for manufacturing a trailing arm including an inner portion, outer portions disposed on both sides of the inner portion, and a rib portion injection-molded on the outer portion, the trailing arm manufacturing method being able to reduce a molding die for injection-molding the rib portion on the outer portion and man-hours thereof.

(1) A trailing arm manufacturing method according to an aspect of the present invention is a trailing arm manufacturing method for manufacturing a trailing arm connecting a vehicle body and a knuckle supporting a vehicle wheel, the trailing arm manufacturing method including: preparing a metallic inner portion and a resinous outer portion composed of at least two components; heat-crimping the inner portion while sandwiching the inner portion with the outer portions in a state in which the inner portion is disposed between the outer portions by using a pair of molding dies including an injection-molding portion for injection-molding a rib portion having a plurality of ribs; and injection-molding the rib portion on the outer portion during the heat-crimping or after the heat-crimping.

With such a method of the above mentioned aspect (1), since the molding die including the injection-molding portion for injection-molding the rib portion is used, the outer portion molding die for molding the outer portion having the rib portion is not necessary and man-hours and costs can be reduced.

(2) In the configuration of the above mentioned aspect (1), a collar through which a bolt for fixing the knuckle passes may be simultaneously crimped to through-holes formed in the inner portion and the outer portion during the heat-crimping.

With such a method of the above mentioned aspect (2), the step dedicated for only crimping the collar can be omitted and the man-hours for the trailing arm can be reduced.

(3) In the configuration of the above mentioned aspect (1) or (2), a bush for connecting the trailing arm to the vehicle body may be simultaneously inserted into a vehicle body side connection portion during the heat-crimping or the injection-molding, the vehicle body side connection portion being formed by the inner portion and a bush fixing resin portion formed on the inner portion at a time of injection-molding the rib portion.

With such a method of the above mentioned aspect (3), a dedicated bush insertion process does not need to be provided and the man-hours for the trailing arm can be reduced.

(4) In the configuration of any one of the above mentioned aspects (1) to (3), the outer portion may be press-molded by a fiber reinforced resin containing reinforcing fibers.

With such a method of the above mentioned aspect (4), the rigidity of the outer portion can be improved, the bead shape for improving the rigidity can be minimized, and the cost can be reduced by simplifying the mold.

(5) In the configuration of the above mentioned aspect (3), during the injection-molding, the bush fixing resin portion may be formed by injected resin and the bush may be crimped to the bush fixing resin portion.

With such a method of the above mentioned aspect (5), the bush can be crimped when injection-molding the rib portion and the bush insertion step does not need to be separately provided.

According to the aspect of the present invention, since the molding die including the injection-molding portion for injection-molding the rib portion is used, the outer portion molding die for molding the outer portion having the rib portion is not necessary and man-hours and costs can be reduced.

### BRIEF DESCRIPTION OF THE DRAWINGS

FIG. 1 is a left side view illustrating a rear suspension of an embodiment of the present invention.

FIG. 2 is a plan view of the rear suspension.

FIG. 3 is a perspective view of a trailing arm provided in the rear suspension.

FIG. 4 is a left side view of an arm body of the trailing arm.

FIG. 5 is a perspective view of the arm body.

FIG. 6 is a perspective view illustrating a configuration of the arm body.

FIG. 7 is a cross-sectional view taken along the line VII-VII of FIG. 1.

FIG. 8 is a cross-sectional view taken along the line VIII-VIII of FIG. 1.

FIG. 9 is a cross-sectional view taken along the line IX-IX of FIG. 4.

FIG. 10 is a cross-sectional view taken along the line X-X of FIG. 4.

FIG. 11 is a diagram illustrating a step of manufacturing the trailing arm.

FIG. 12 is a perspective view of a molding die of the trailing arm.

FIG. 13 is a perspective view showing a state in which a collar is disposed in the molding die.

FIG. 14A is an enlarged perspective view of a collar arrangement portion of a left molding die of the molding die.

FIG. 14B is an enlarged perspective view of a collar arrangement portion of a right molding die of the molding die.

FIG. 15 is a perspective view illustrating a state in which a rubber bush is inserted into the molding die.

FIG. 16 is a left side view showing the rubber bush of the trailing arm and the periphery thereof.

### DETAILED DESCRIPTION OF THE INVENTION

Hereinafter, an embodiment of the present invention will be described with reference to the drawings. Unless otherwise specified, the directions such as front, rear, left, and right in the following description are the same as the directions in the vehicle equipped with a trailing arm 5 described below. Further, an arrow FR indicating the front side of the vehicle, an arrow LH indicating the left side of the vehicle, and an arrow UP indicating the upper side of the vehicle are shown in the appropriate place of the figure used in the following description.

<Trailing Arm Type Suspension>

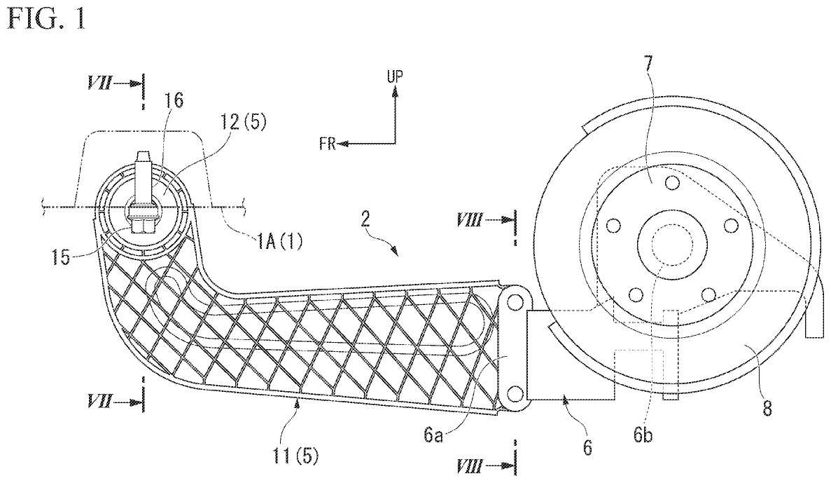

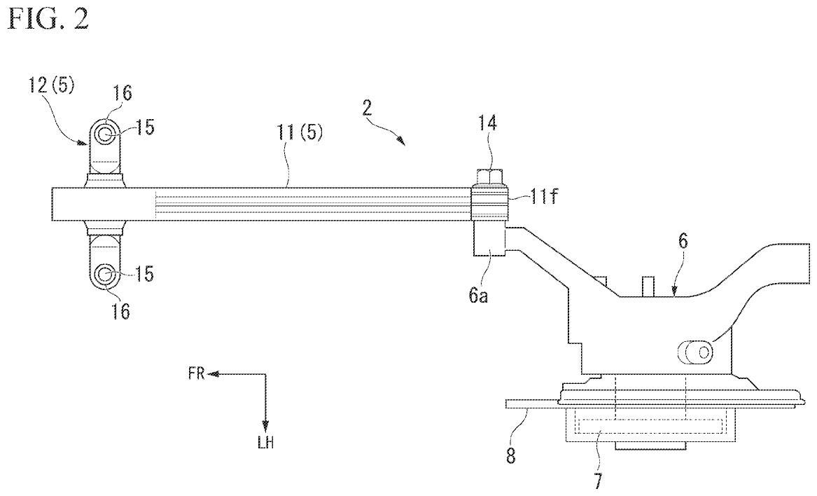

FIG. 1 is a left side view illustrating a rear suspension 2. FIG. 2 is a plan view of the rear suspension 2.

As shown in FIGS. 1 and 2, a vehicle body 1 of the vehicle includes a pair of left and right rear frames 1A at the rear portion and the rear suspension (so-called trailing arm type suspension) 2 is attached to the left and right rear frames 1A.

A trailing arm 5 which is attached to the lower portion of the rear frame 1A, a knuckle 6 which is fixed to the rear end portion of the trailing arm 5, and a hub 7 which is rotatably supported by the knuckle 6 is provided on each of the left and right sides of the rear suspension 2. A vehicle wheel (rear wheel (not shown)) is attached to the left and right hubs 7.

The rear suspension 2 includes various arms which connect the vehicle body 1 and the knuckle 6 and extend in the vehicle width direction, a vibration damping mechanism, an elastic member (for example, a spring), a stabilizer, and the like in addition to the above-described members and suspends the left and right rear wheels with respect to the vehicle body 1.

The trailing arm 5 includes an arm body 11 which is formed in a plate shape and a rubber bush (bush) 12 which is fixed to the front end portion of the arm body 11. The trailing arm 5 extends backward from the vehicle body 1 and connects the vehicle body 1 and the knuckle 6.

The arm body 11 is disposed so that the longitudinal direction of the cross-section of the rear portion is directed in the up and down direction. The arm body 11 includes a knuckle connection portion 11f which is provided at the rear end portion of the arm body 11 and fastens and connects a trailing arm connection portion 6a provided at the front end portion of the knuckle 6 by a plurality of bolts 14.

Both end portions of the rubber bush 12 in the vehicle width direction are respectively fastened to the rear frame 1A by a bolt 15 and a nut 16.

The knuckle 6 includes the trailing arm connection portion 6a which is integrally provided with the front end portion of the knuckle and an axle 6b which is integrally provided with the rear portion thereof. The hub 7 is rotatably supported by the axle 6b. A vehicle wheel (rear wheel) (not shown) and a brake disc 8 constituting a disc brake are attached to the hub 7 of the axle 6b. Additionally, the axle 6b may be supported by the knuckle 6 to be rotatable and the hub 7 may be supported by the axle 6b not to be rotatable.

<Trailing Arm>

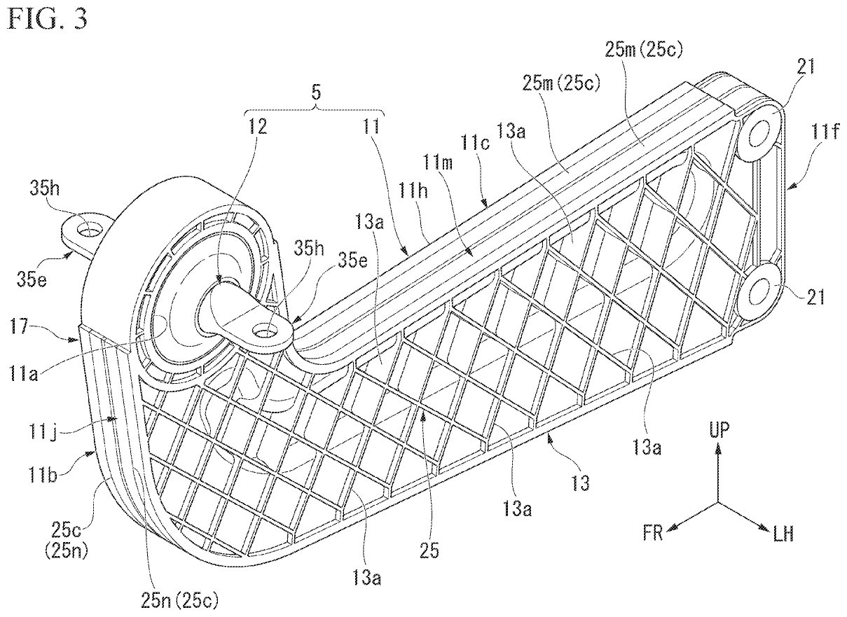

FIG. 3 is a perspective view of the trailing arm 5.

As shown in FIG. 3, the arm body 11 is integrally provided with a vertical extension portion 11b, which extends in the up and down direction and of which an upper portion is provided with a bush mounting hole 11a for mounting a rubber bush 12, and a rear extension portion 11c which extends backward from the lower portion of the vertical extension portion 11b.

One side portion (left side portion) of the arm body 11 is provided with a pair of left and right resinous rib portions 13 and 17 which are composed of a plurality of ribs 13a such that the plurality of ribs 13a are arranged in a lattice shape. These rib portions 13 and 17 increase the rigidity of the arm body 11. Since the plurality of ribs 13a are arranged in a lattice shape, it is possible to further increase the rigidity of the arm body 11. The knuckle connection portion 11f to be connected to the knuckle 6 (see FIG. 2) is provided at the rear end portion of the arm body 11. The knuckle connection portion 11f is provided with a pair of upper and lower metallic collars 21 each allowing a bolt 14 (see FIG. 2) to pass therethrough.

The rubber bush 12 includes a pair of left and right pivot brackets 35e which protrudes toward both sides in the vehicle width direction from the vertical extension portion 11b of the arm body 11. The pivot bracket 35e has a bolt insertion hole 35h formed at a flat portion of each end portion and is fastened to the rear frame 1A (see FIG. 1) by the bolt 15 (see FIG. 2) passing through the bolt insertion hole 35h and the nut 16 (see FIG. 2).

<Arm Body>

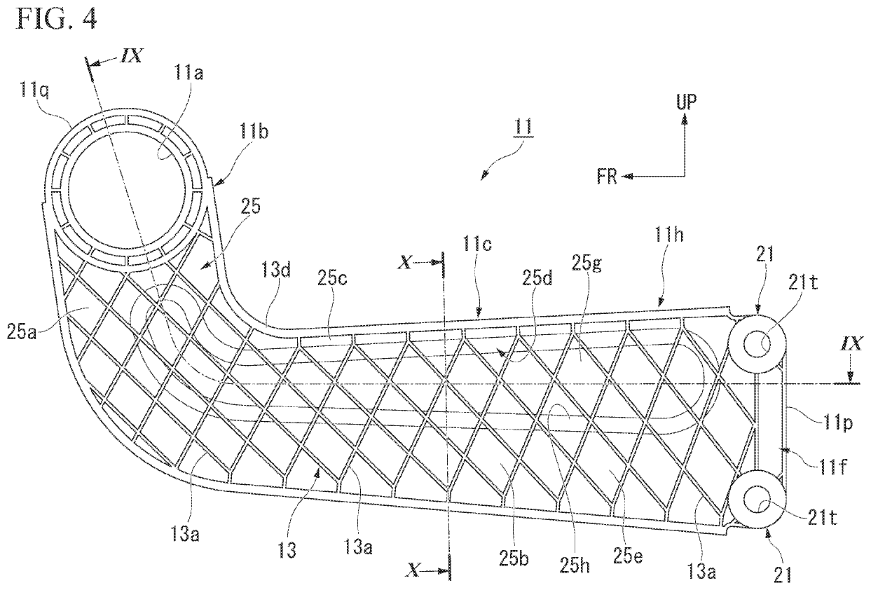

FIG. 4 is a left side view of the arm body 11.

As shown in FIG. 4, the arm body 11 is formed such that a pair of left and right resinous plate members (outer portions) 25 is disposed on the inside of the rib portions 13 and 17 (the rib portion 17 is shown in FIG. 3) in the vehicle width direction. The plate member 25 is integrally provided with a vertical extension plate portion 25a which is formed at the front portion to extend in the up and down direction and a rear extension plate portion 25b which extends backward from the lower portion of the vertical extension plate portion 25a. The plate member 25 has a plate concave portion (concave portion) 25d which has an L shape in the side view and is formed on the inside of a peripheral edge portion 25c so as to extend from the vertical extension plate portion 25a to the rear extension plate portion 25b.

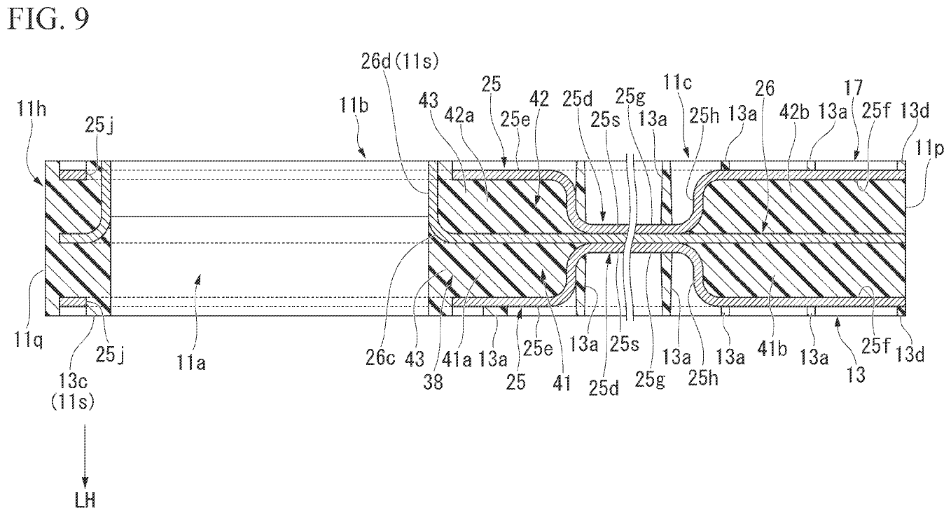

The plate concave portion 25d is recessed to a uniform depth from an outer surface 25e (that is, a surface on the outside of the vehicle width direction) of the plate member 25 toward an inner surface 25f (that is, a surface on the inside of the vehicle width direction (see FIG. 9)) of the plate member 25. The plate concave portion 25d includes a bottom surface 25g and an annular side surface 25h which rises from the peripheral edge of the bottom surface 25g.

Each rib 13a of the rib portion 13 is formed to be in close contact with an outer surface 25e of the plate member 25 and the bottom surface 25g and the side surface 25h of the plate concave portion 25d.

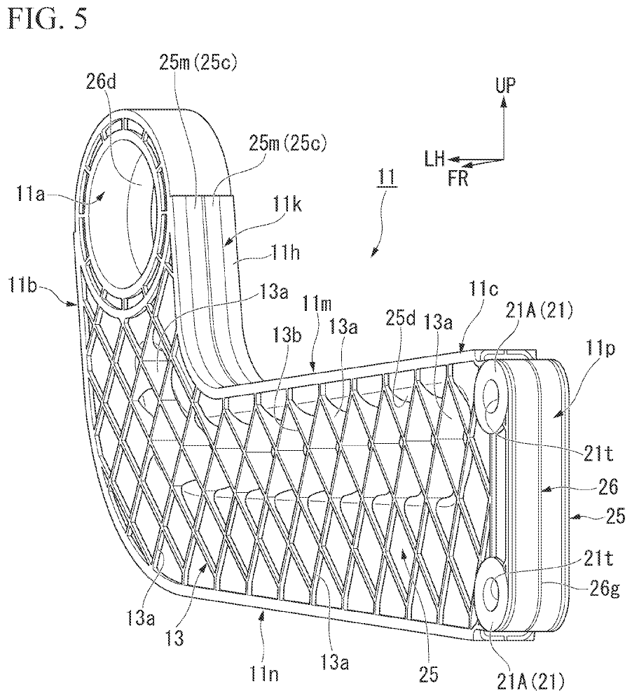

FIG. 5 is a perspective view of the arm body 11.

As shown in FIGS. 4 and 5, an end surface 13b on the outside of the vehicle width direction of each rib 13a of the rib portion 13 is located on the same plane. Therefore, in each rib 13a, the height from the portion in contact with the plate member 25 to the end surface 13b is higher in the portion with the plate concave portion 25d of the plate member 25 than the portion without the plate concave portion 25d. In this way, when the plate concave portion 25d is provided in the plate member 25 and the height of each rib 13a of the rib portion 13 formed on the outside of the vehicle width direction of the plate member 25 becomes higher in the plate concave portion 25d, the rigidity of the arm body 11 can be increased.

As shown in FIGS. 3 and 5, in a lower portion of each of a front surface 11j and a rear surface 11k of the vertical extension portion 11b and an upper surface 11m, a lower surface 11n, and a rear surface 11p of the rear extension portion 11c, the peripheral edge portion 25c of the plate member 25 is exposed to the outside. Further, in the rear surface 11p of the arm body 11, a rear edge portion 26g of an inner plate (inner portion) 26 to be described later is exposed to the outside.

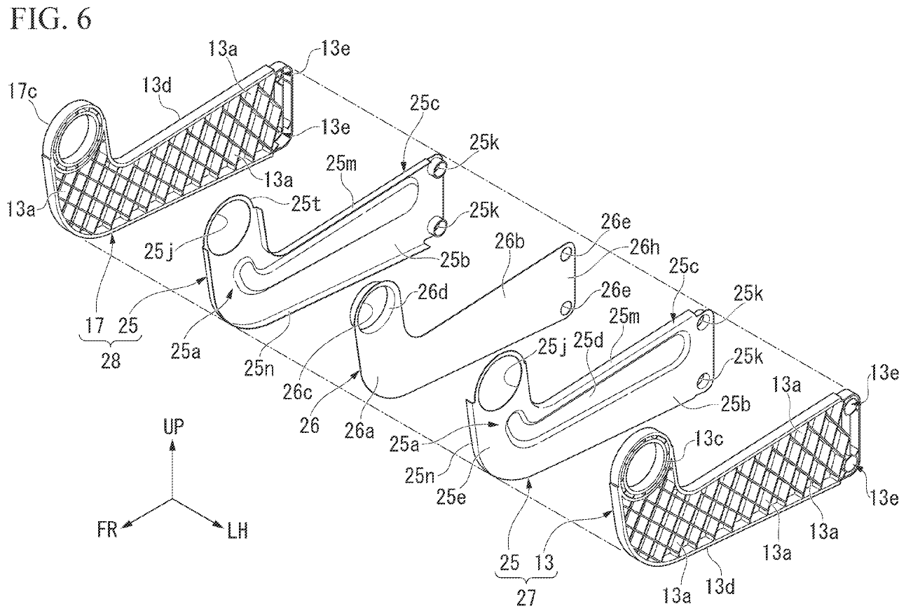

FIG. 6 is a perspective view illustrating a configuration of the arm body 11.

As shown in FIG. 6, a metallic inner plate 26 is disposed at the center portion of the arm body 11 (see FIG. 3) in the vehicle width direction and outer members 27 and 28 are respectively disposed on both sides of the inner plate 26 in the vehicle width direction.

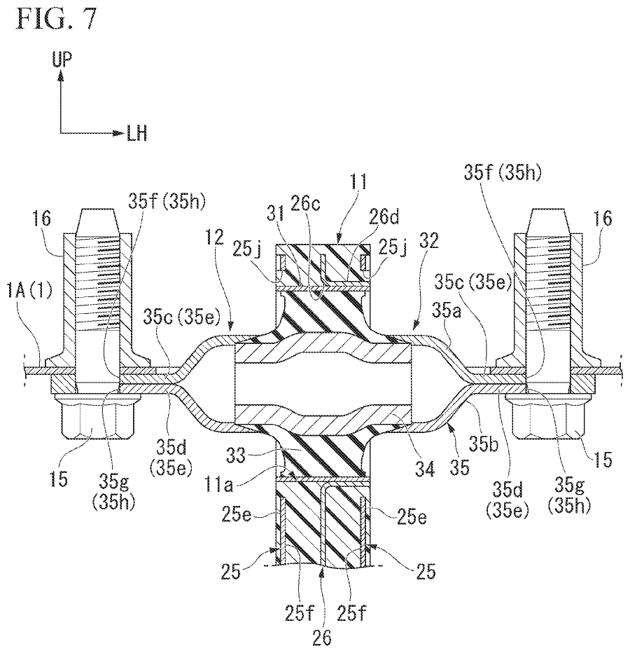

The outer member 27 includes the plate member 25 that is crimped to the inner plate 26 from one side (left side) of the vehicle width direction and the rib portion 13 which is injection-molded on the outer surface 25e of the plate member 25. The outer member 28 includes the plate member 25 that is crimped to the inner plate 26 from the other side (right side) of the vehicle width direction and the rib portion 17 which is injection-molded on the outer surface 25e (see FIG. 7) of the plate member 25.

The inner plate 26 and the left and right plate members 25 are joined (specifically, heat-crimped) in a pair of molding dies and the rib portions 13 and 17 are injection-molded on each plate member 25 in the same pair of molding dies.

The inner plate 26 is made of a pressed plate material and is integrally provided with a vertical extension plate portion 26a which is formed at the front portion of the inner plate 26 so as to extend in the up and down direction and a rear extension plate portion 26b which extends backward from the lower portion of the vertical extension plate portion 26a.

The vertical extension plate portion 26a includes a vehicle body side inner through-hole 26c. The edge portion of the vehicle body side inner through-hole 26c is subjected to burring work. Accordingly, a cylindrical rising portion 26d is formed to protrude toward one side (right side) of the vehicle width direction. The rising portion 26d constitutes a part of the bush mounting hole 11a (see FIG. 5) of the arm body 11 (see FIG. 5). The rubber bush 12 (see FIG. 3) is fitted to the rising portion 26d similarly to other portions of the bush mounting hole 11a. The rising portion 26d forms a seat surface for fixing the rubber bush 12 to the arm body 11.

A knuckle side inner connection portion 26h which is connected to the knuckle 6 (see FIG. 2) is provided at the rear end portion of the rear extension plate portion 26b of the inner plate 26. The knuckle side inner connection portion 26h includes a pair of upper and lower knuckle side inner through-holes 26e. The collars 21 (see FIG. 5) are respectively inserted through the pair of knuckle side inner through-holes 26e.

The plate member 25 is made of a fiber reinforced resin containing, for example, carbon fiber as the reinforcing fiber, and the strength is increased. In addition to carbon fiber, the reinforcing fiber may be a fiber reinforced resin containing glass fiber, boron fiber, polyamide fiber, Kevlar (registered trademark) fiber, Izanas (registered trademark), and Zylon (registered trademark).

The plate member 25 is formed in advance with another molding die before the arm body 11 is molded with the molding die. The upper portion of the vertical extension plate portion 25a is integrally provided with a vehicle body side outer connection portion 25t which is formed in an annular shape and is connected to the knuckle 6 (see FIG. 2). The vehicle body side outer connection portion 25t includes a vehicle body side outer through-hole 25j.

The inner diameter of the vehicle body side outer through-hole 25j is formed to be larger than that of the vehicle body side inner through-hole 26c of the inner plate 26 in order to form the bush mounting hole 11a.

The rear end portion of the rear extension plate portion 25b is integrally provided with a pair of upper and lower outer tubular portions 25k. The pair of outer tubular portions 25k is formed to protrude toward the inner plate 26 and the collar 21 is inserted into each of them to be crimped.

The plate member 25 includes an upper flange portion 25m and a lower flange portion 25n which are bent toward the inner plate 26 over the edge portion of the vertical extension plate portion 25a and the edge portion of the rear extension plate portion 25b. The upper flange portion 25m and the lower flange portion 25n constitute a part of the peripheral edge portion 25c of the plate member 25. In this way, when the upper flange portion 25m and the lower flange portion 25n are provided, the rigidity of the pair of plate members 25 can be increased.

The rib portion 13 includes a one-side edge portion (bush fixing resin portion) 13c which is an edge portion of the bush mounting hole 11a on one side (left side) of the vehicle width direction, a peripheral edge portion 13d which excludes the edge portion 13c of the bush mounting hole 11a, and a plurality of ribs 13a which are formed on the inside of the one-side edge portion 13c and the peripheral edge portion 13d.

The rib portion 17 includes the other-side edge portion 17c which is the edge portion of the bush mounting hole 11a on the other side (right side) of the vehicle width direction, the peripheral edge portion 13d, and the plurality of ribs 13a which are formed on the inside of the other-side edge portion 17c and the peripheral edge portion 13d. The rib portion 17 is different from the rib portion 13 only in the other-side edge portion 17c due to the arrangement of the rising portion 26d of the inner plate 26.

The rib portions 13 and 17 include a collar arrangement portion 13e which is formed at the rear end portion so that a part of the pair of collars 21 (see FIG. 5) is disposed.

<Vehicle Body Side Attachment Structure of Trailing Arm>

As shown in FIG. 7, the rubber bush 12 includes an outer tube 31, an inner tube 32 which is disposed in the outer tube 31, and a rubber 33 which is disposed between the outer tube 31 and the inner tube 32. The outer tube 31 is press-fitted into the bush mounting hole 11a of the arm body 11. The inner tube 32 includes an internal side inner tube 34 to which the rubber 33 is attached and an external side outer tube 35 which is attached to both end portions of the internal side inner tube 34.

The external side outer tube 35 is a member in which an upper half body 35a and a lower half body 35b are combined. The upper half body 35a has an upper bracket 35c formed at both end portions of the upper half body 35a and the lower half body 35b has a lower bracket 35d formed at both end portions of the upper half body 35a.

The upper bracket 35c and the lower bracket 35d constitute the pivot bracket 35e.

The upper bracket 35c includes an upper through-hole 35f which penetrates vertically and the lower bracket 35d includes a lower through-hole 35g which penetrates vertically. The upper through-hole 35f and the lower through-hole 35g form the bolt insertion hole 35h of the pivot bracket 35e.

The left and right pivot brackets 35e are respectively fastened to the left and right rear frames 1A of the vehicle body 1 by the bolt 15 passing through the bolt insertion hole 35h and the nut 16.

<Knuckle Side Attachment Structure of Trailing Arm>

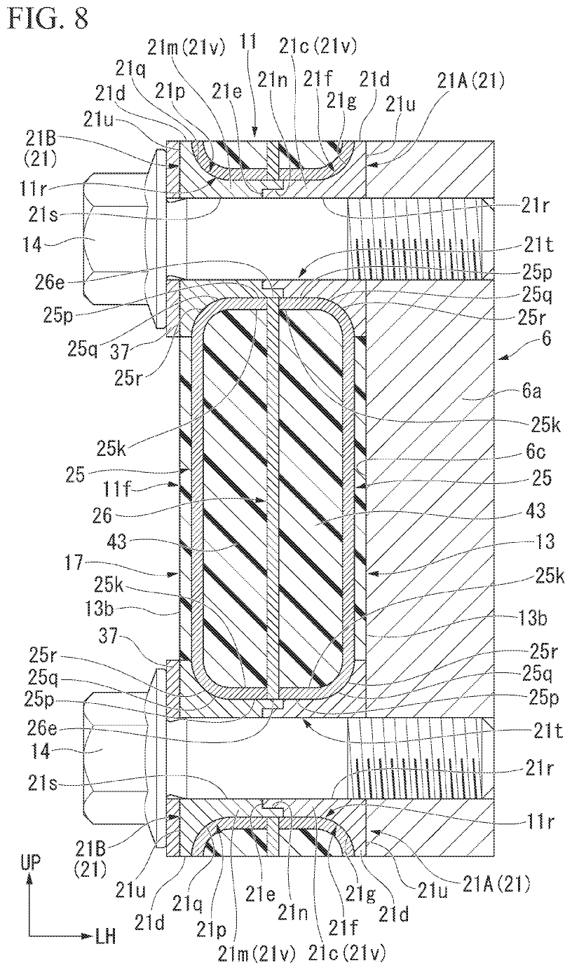

FIG. 8 is a cross-sectional view taken along the line VIII-VIII of FIG. 1.

As shown in FIG. 8, each outer tubular portion 25k of the left and right plate members 25 includes a collar insertion hole 25p through which each collar 21 is inserted in order to attach the arm body 11 to the knuckle 6 (see FIG. 2).

Each collar insertion hole 25p of the left and right plate members 25 and the knuckle side inner through-hole 26e of the inner plate 26 form a collar through-hole (through-hole) 11r into which the collar 21 is inserted and crimped. As described above, the collar through-hole 11r is formed over the left and right plate members 25 and the inner plate 26 and is provided in the knuckle connection portion 11f.

The collar 21 includes a first collar (collar) 21A which is disposed in the arm body 11 on one side (left side) of the vehicle width direction and a second collar (collar) 21B which is disposed in the arm body 11 on the other side (right side) of the vehicle width direction. The first collar 21A is inserted and crimped into the collar insertion hole 25p of the plate member 25 on one side (left side) of the vehicle width direction. The second collar 21B is inserted and crimped into the collar insertion hole 25p of the plate member 25 on the other side (right side) of the vehicle width direction and one side (left side) of the vehicle width direction.

Additionally, the first collar 21A may be inserted and crimped into the collar insertion hole 25p of the plate member 25 on one side (left side) of the vehicle width direction and the other side (right side) of the vehicle width direction. Further, the second collar 21B may be inserted and crimped only into the collar insertion hole 25p of the plate member 25 on the other side (right side) of the vehicle width direction.

The first collar 21A is integrally provided with a first tubular portion 21c and a flange portion 21d extending radially outward from one end portion of the first tubular portion 21c. The other end portion of the first tubular portion 21c is integrally provided with a convex portion 21e.

A first corner portion 21f formed by the first tubular portion 21c and the flange portion 21d is provided with a first curved surface portion 21g formed on a concave curved surface. The first curved surface portion 21g is formed in an annular shape along the outer peripheral surfaces of the first tubular portion 21c and the flange portion 21d and the cross-section of the first curved surface portion 21g is formed in a concave arc shape.

The second collar 21B is integrally provided with a second tubular portion 21m and a flange portion 21d extending radially outward from one end portion of the second tubular portion 21m. The other end portion of the second tubular portion 21m is provided with a concave portion 21n. The first tubular portion 21c of the first collar 21A and the second tubular portion 21m of the second collar 21B constitute a tubular portion 21v of the collar 21. Since the tubular portion 21v is inserted into the collar through-hole 11r, the deviation between the inner plate 26 and the left and right plate members 25 (specifically, the deviation in the extension direction of the inner plate 26) is suppressed when the left and right plate members 25 are joined to the inner plate 26.

A second corner portion 21p formed by the second tubular portion 21m and the flange portion 21d is provided with a second curved surface portion 21q formed on a concave curved surface. The second curved surface portion 21q is formed in an annular shape along the outer peripheral surfaces of the second tubular portion 21m and the flange portion 21d and the cross-section of the second curved surface portion 21q is formed in a concave arc shape. The second curved surface portion 21q is formed in the same shape as the first curved surface portion 21g.

An end surface 21u of the flange portion 21d of the first collar 21A is disposed to be flush with an end surface 13b of the rib portion 13. A side surface 6c of the trailing arm connection portion 6a of the knuckle 6 comes into contact with the end surface 21u.

The end surface 21u of the flange portion 21d of the second collar 21B is flush with the end surface 13b of the rib portion 17. A washer 37 through which the bolt 14 passes comes into contact with the end surface 21u.

The first tubular portion 21c and the second tubular portion 21m have the same outer diameter and inner diameter. The outer diameter of the flange portion 21d is larger than those of the first tubular portion 21c and the second tubular portion 21m.

The convex portion 21e of the first collar 21A and the concave portion 21n of the second collar 21B has mating-connection. Due to the mating-connection, the first tubular portion 21c and the second tubular portion 21m can be coaxially arranged with high accuracy.

The first tubular portion 21c of the first collar 21A includes a first bolt insertion hole 21r through which the bolt 14 passes. The second tubular portion 21m of the second collar 21B includes a second bolt insertion hole 21s through which the bolt 14 passes. The first bolt insertion hole 21r and the second bolt insertion hole 21s constitute a bolt insertion hole 21t.

The second collar 21B is inserted and crimped into the knuckle side inner through-hole 26e of the inner plate 26. The tip end of each outer tubular portion 25k of the left and right plate members 25 is crimped to the edge portion of the knuckle side inner through-hole 26e of the inner plate 26. Additionally, the first collar 21A may be inserted and crimped into the knuckle side inner through-hole 26e or both the first collar 21A and the second collar 21B may be inserted and crimped thereinto.

A convex through-hole side curved surface portion 25r is formed on the edge portion 25q of the collar insertion hole 25p of the plate member 25. The through-hole side curved surface portion 25r is formed in an annular shape along the inner peripheral surface of the collar insertion hole 25p and the cross-section of the through-hole side curved surface portion 25r is formed in a convex arc shape.

The first curved surface portion 21g and the second curved surface portion 21q which are formed as concave curved surfaces in the collar 21 and each through-hole side curved surface portion 25r formed as a convex curved surface in the plate member 25 have the same curvature and each portion is evenly in contact with each other. Thus, the contact area between the first curved surface portion 21g and the second curved surface portion 21q with respect to each through-hole side curved surface portion 25r can be increased. Accordingly, it is possible to reduce stress concentration by improving the adhesion at the contact portion between the first corner portion 21f and the second corner portion 21p of the collar 21 and the edge portion 25q of the collar insertion hole 25p of the plate member 25.

In FIGS. 6 to 8, the inner plate 26 includes the rising portion 26d which is connected to the vehicle body 1 through the rubber bush 12 and the knuckle side inner connection portion 26h which is connected to the knuckle 6 through the collar 21 and the bolt 14. The metallic inner plate 26 connects the vehicle body 1 and the knuckle 6.

The plate member 25 includes the vehicle body side outer connection portion 25t which is connected to the vehicle body 1 via a resin material 43 and the rubber bush 12 and the outer tubular portion 25k which is connected to the knuckle 6 via the collar 21 and the bolt 14. Further, the plate member 25 is disposed between the vehicle body side outer connection portion 25t and the outer tubular portion 25k. The plate member 25 includes the plate concave portion 25d which increases the rigidity between the vehicle body side outer connection portion 25t and the outer tubular portion 25k in the plate member 25.

<Arm Body Cross-Section Structure>

FIG. 9 is a cross-sectional view taken along the line IX-IX of FIG. 4.

As shown in FIG. 9, a hollow portion 38 is formed on the inside of the pair of left and right plate members 25 and the inner plate 26 is disposed and joined to the hollow portion 38. The hollow portion 38 is divided into left and right by the inner plate 26. That is, a space 41 is formed in the inner plate 26 on one side (left side) of the vehicle width direction and a space 42 is formed in the inner plate 26 on the other side (right side) of the vehicle width direction. The spaces 41 and 42 are respectively filled with the resin material 43.

The space 41 includes a first space portion 41a which is located at the vertical extension portion 11b and a second space portion 41b which is located at the rear extension portion 11c. The first space portion 41a and the second space portion 41b communicate with each other above and below the plate concave portion 25d (also see FIG. 4) of the left plate member 25.

The space 42 includes a first space portion 42a which is located at the vertical extension portion 11b and a second space portion 42b which is located at the rear extension portion 11c. The first space portion 42a and the second space portion 42b communicate with each other above and below the plate concave portion 25d of the right plate member 25.

The resin material 43 is formed such that a molten resin injected into molding dies when injection-molding the left and right rib portions 13 and 17 flows into the spaces 41 and 42 and is filled and solidified in the spaces 41 and 42. In this way, since the spaces 41 and 42 are filled with the resin material 43, it is possible to improve the strength and rigidity of the arm body 11.

Since the spaces 41 and 42 are open to the outside in a convex arc surface 11q forming the upper end of the vertical extension portion 11b and the rear surface 11p of the rear extension portion 11c among an outer peripheral surface 11h of the arm body 11, the resin material 43 is exposed to the outside. Further, since the space 41 is open to the outside also in the inner peripheral surface of the bush mounting hole 11a, the resin material 43 is exposed to the outside. On the other hand, since the space 42 is blocked by the rising portion 26d of the inner plate 26 also in the inner peripheral surface of the bush mounting hole 11a, the resin material 43 is not exposed to the outside.

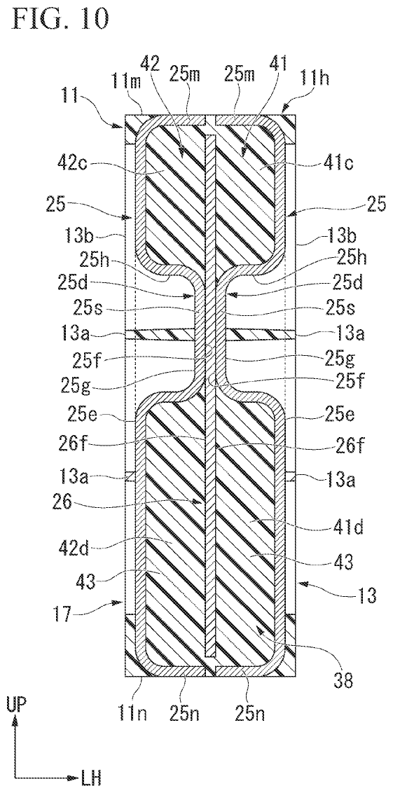

FIG. 10 is a cross-sectional view taken along the line X-X of FIG. 4.

As shown in FIG. 10, each plate concave portion 25d includes a bottom wall 25s forming the bottom surface 25g. The pair of bottom walls 25s forming the plate concave portions 25d of the left and right plate members 25 is crimped to the inner plate 26 while sandwiching the inner plate 26 from both sides. In other words, the inner surface 25f which is a surface on the side of the inner plate 26 in the left and right plate members 25 is crimped to surfaces 26f on both sides of the inner plate 26.

The plate member 25 is positioned to both sides of the inner plate 26 in the plate thickness direction of the arm body 11 in such a manner that the bottom wall 25s is brought into contact with the inner plate 26. Since the bottom wall 25s is joined to the inner plate 26 by the surface, it is possible to increase the joint strength.

A third space portion 41c and a fourth space 41d constituting the space 41 are arranged in the periphery of the plate concave portion 25d on one side (left side). A third space portion 42c and a fourth space 42d constituting the space 42 are arranged in the periphery of the plate concave portion 25d on the other side (right side).

The rib portion 13 is formed on the outer surface 25e on the side opposite to the arrangement side of the third space portion 41c and the fourth space 41d with respect to the plate member 25 on one side (left side). The rib portion 17 is formed on the outer surface 25e on the side opposite to the arrangement side of the third space portion 42c and the fourth space 42d with respect to the plate member 25 on the other side (right side).

Each rib 13a of the rib portions 13 and 17 is formed along the shape of the outer surface 25e of the plate member 25. That is, each rib 13a extends from the end surface 13b to the outer surface 25e on the outside of the vehicle width direction in the third space portion 41c, the fourth space 41d, the third space portion 42c, and the fourth space 42d and extends from the end surface 13b to the bottom surface 25g or the side surface 25h in the plate concave portion 25d. In the plate concave portion 25d, the height of each rib 13a becomes higher than that of a portion other than the plate concave portion 25d.

In the upper surface 11m and the lower surface 11n of the rear extension portion 11c among the outer peripheral surface 11h of the arm body 11, the spaces 41 and 42 are covered with the upper flange portion 25m and the lower flange portion 25n of each of the left and right plate members 25. Therefore, the upper flange portion 25m and the lower flange portion 25n of each of the left and right plate members 25 are exposed to the outside, but the resin material 43 is not easily exposed to the outside. Accordingly, it is possible to suppress the bending of the resin material 43 in the spaces 41 and 42 when a bending moment in the up and down direction is applied to the rear extension portion 11c of the arm body 11.

<Trailing Arm Manufacturing Method>

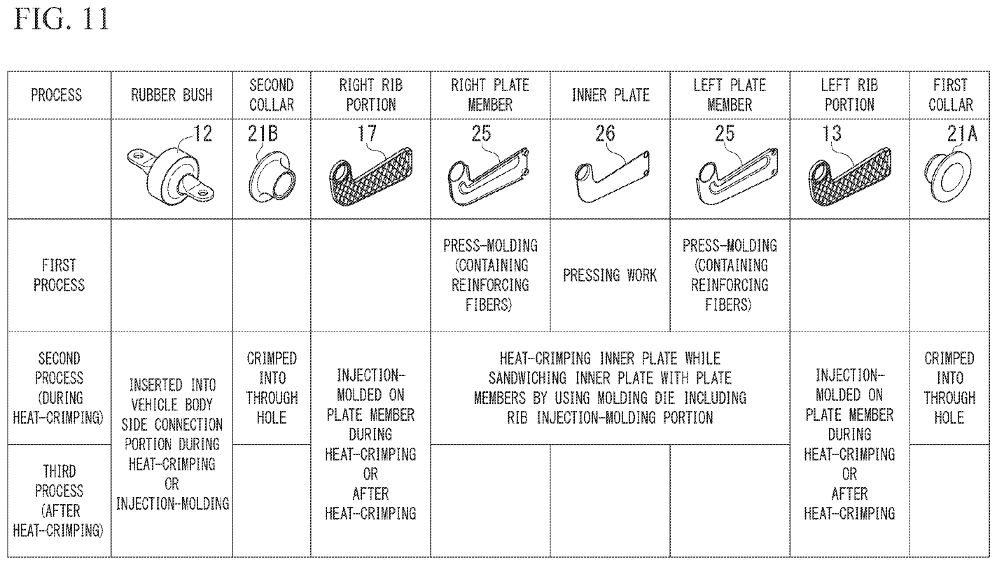

Next, each of the manufacturing steps of the trailing arm 5 will be described below with reference to FIGS. 11 to 16.

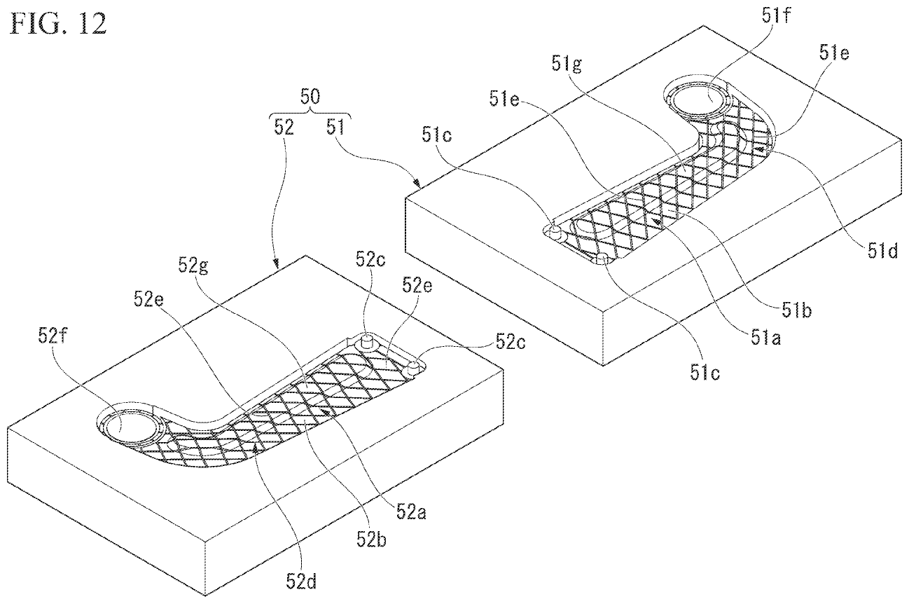

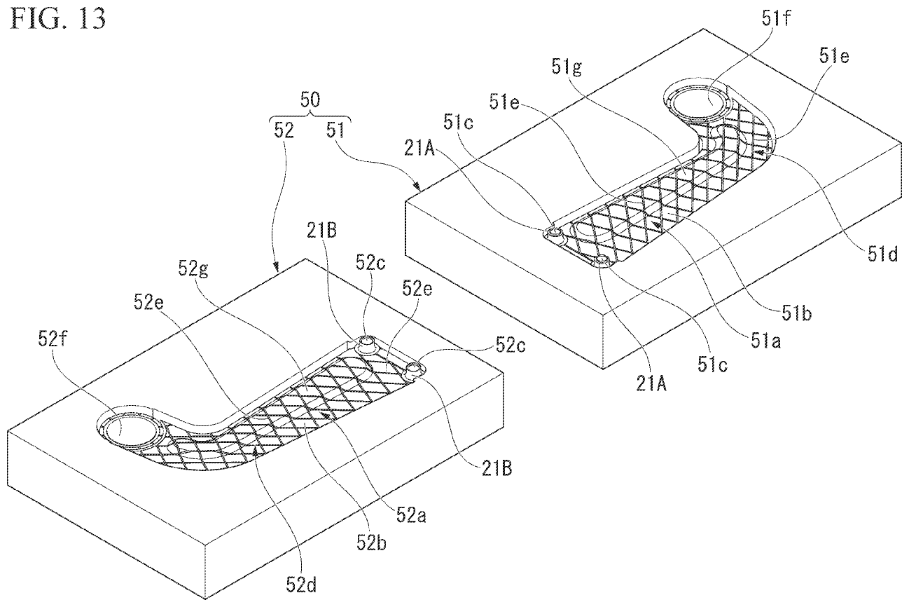

FIG. 11 is a diagram illustrating the manufacturing steps of the trailing arm 5. FIG. 12 is a perspective view of a molding die 50 of the trailing arm 5. FIG. 13 is a perspective view showing a state in which the collars 21A and 21B are disposed on the molding die 50.

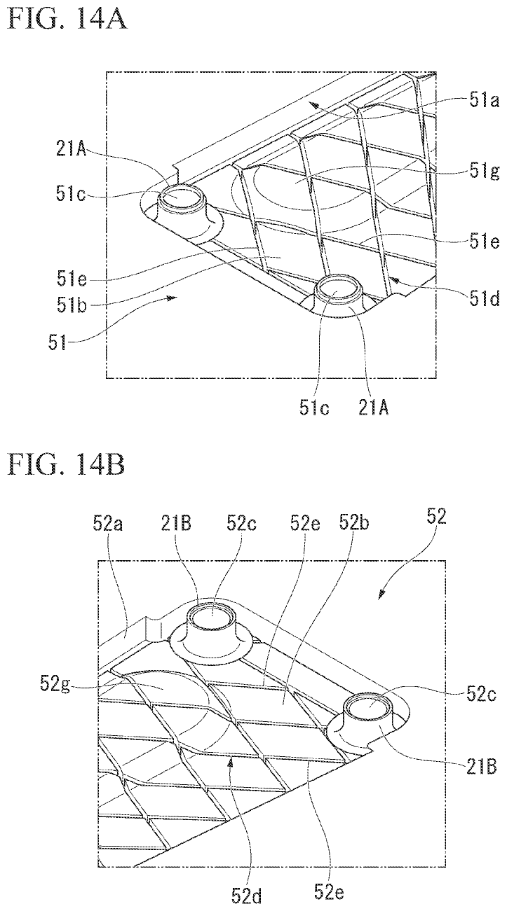

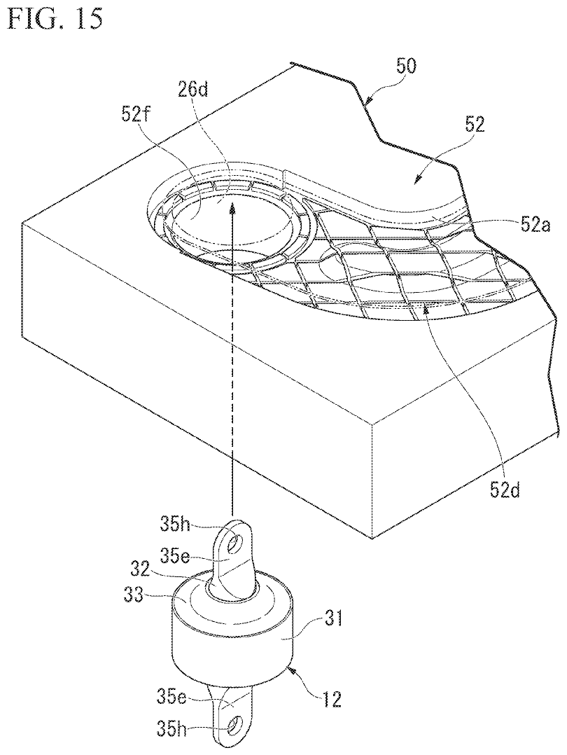

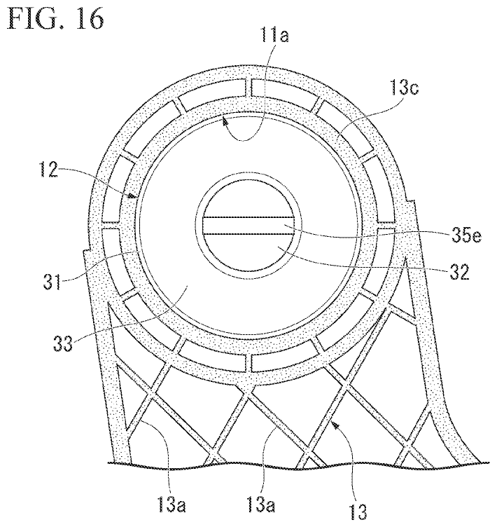

FIG. 14A is an enlarged perspective view of the collar arrangement portion 13e of a left molding die 51 of the molding die 50. FIG. 14B is an enlarged perspective view of the collar arrangement portion 13e of a right molding die 52 of the molding die 50. FIG. 15 is a perspective view showing a state in which the rubber bush 12 is inserted into the molding die 50. FIG. 16 is a left side view of the rubber bush 12 of the trailing arm 5 and the periphery thereof. In addition, the contents related to the manufacturing steps will be described timley with reference to FIGS. 12 to 16 in the description of the manufacturing steps of FIG. 11. In FIG. 16, a plurality of dots are drawn on the rib portion 13.

As shown in FIG. 11, in a first process, the inner plate 26 is formed by performing a pressing work on a metal flat plate. Further, the left and right plate members 25 are formed by stacking a predetermined number of prepregs impregnated with resin on sheet-shaped reinforcing fibers (carbon fibers) and press-molding (heat-pressing) the resultant. The left and right plate members 25 are made of a fiber reinforced resin.

In this way, in the first process, the inner plate 26 and the pair of plate members 25 are prepared.

In a second process, the inner plate 26 and the pair of plate members formed by the first process are inserted into the closed molding die 50 including the left molding die (molding die) 51 and the right molding die (molding die) 52 shown in FIG. 12 and the inner plate 26 is disposed between the pair of plate members 25 in FIG. 11. Then, in this state, the inner plate 26 is heat-crimped while being sandwiched between the pair of plate members 25 from both sides.

Further, during heat-crimping in the second process, as shown in FIGS. 12 and 13, the pair of first collars 21A and the pair of second collars 21B disposed in a specified portion in the molding die 50 in advance are inserted and crimped into the collar through-hole 11r (see FIG. 8) at the same time as the above mentioned heat-crimping.

The specified portion in the molding die 50 are a pair of columnar convex portions 51c formed at one end portion of a bottom surface 51b of the cavity 51a in the left molding die 51 and a pair of columnar convex portions 52c formed at one end portion of a bottom surface 52b of the cavity 52a in the right molding die 52. The first collar 21A is fitted to each of the pair of convex portions 51c and the second collar 21B is fitted to each of the pair of convex portions 52c.

At the time of heat-crimping in the second process, as shown in FIG. 15, the rubber bush 12 (specifically, the outer tube 31 of the rubber bush 12) is inserted into the rising portion 26d (see FIG. 15) of the inner plate 26 in the molding die 50 as indicated by an arrow at the same time as the heat-crimping at a timing in which the first collar 21A and the second collar 21B are disposed in the molding die 50 in advance. The insertion of the rubber bush 12 into the rising portion 26d may be performed after the heat-crimping (third process).

Further, the molten resin is injected into the molding die 50 during the heat-crimping in the second process or after the heat crimping (third process). In FIG. 12, since the rib molding portions (injection-molding portions) 51d and 52d respectively molding the rib portions 13 and 17 are provided in the pair of left and right molding dies 51 and 52, the rib portions 13 and 17 are respectively injection-molded on the outer surfaces of the pair of plate members 25 in the molding die 50. In this way, in the second process or the third process, the rib portions 13 and 17 are injection-molded on the pair of plate members 25.

The rib molding portions 51d and 52d respectively include groove portions 51e and 52e (see FIG. 12) provided in the bottom surfaces 51b and 52b to respectively form the plurality of ribs 13a (see FIG. 9).

At the time of the injection-molding, as shown in FIGS. 15 and 16, a molten resin injected into the molding die 50 forms the one-side edge portion 13c (also see FIG. 9) other than the rising portion 26d (also see FIG. 9) of the bush mounting hole 11a so that the rubber bush 12 is injection-molded and crimped to the completed bush mounting hole 11a. The one-side edge portion 13c is made of the resin material 43 (see FIG. 9).

At least the rising portion 26d and the one-side edge portion 13c constitute a vehicle body side connection portion 11s (see FIG. 9) formed on the edge portion of the bush mounting hole 11a in order to support the rubber bush 12.

The outer tube 31 of the rubber bush 12 is press-fitted into the rising portion 26d and crimped to the one-side edge portion 13c.

Each of the inserting of the rubber bush 12 into the rising portion 26d and the crimping of the rubber bush 12 to the bush mounting hole 11a is included in the attaching of the rubber bush 12 to the vehicle body side connection portion 11s.

Additionally, in FIG. 12, in the left molding die 51, a columnar bush hole forming portion 51f forming a left half portion of the bush mounting hole 11a (see FIG. 16) and a plate concave portion fitting portion 51g fitted to the plate concave portion 25d (see FIG. 6) of the left plate member 25 (see FIG. 6) are provided in the bottom surface 51b.

The right molding die 52 includes a columnar movable die 52f which is fitted to the rising portion 26d of the inner plate 26 and is attachable to and detachable from in the axial direction of the rising portion 26d and a plate concave portion fitting portion 52g which is formed on the bottom surface 52b so as to be fitted to the plate concave portion 25d (see FIG. 10) of the right plate member 25. By removing the movable die 52f, the rubber bush 12 can be inserted into the molding die 50 and a cooling device (not shown) cooling the rubber bush 12 can be also inserted thereinto.

As described above, the trailing arm manufacturing method of the above-described embodiment includes: preparing the metallic inner plate 26 and the resinous plate member 25 composed of at least two components; heat-crimping the inner plate 26 while sandwiching the inner portion with the plate members 25 in a state in which the inner plate 26 is disposed between the plate members 25 by using the pair of left and right molding dies 51 and 52 including the rib molding portions 51d and 52d for injection-molding the rib portions 13 and 17 having the plurality of ribs 13a; and injection-molding the rib portions 13 and 17 on the plate member 25 during the heat-crimping or after the heat-crimping.

In this way, since the molding die 50 including the rib molding portions 51d and 52d for injection-molding the rib portions 13 and 17 is used, the outer portion molding die for molding the plate member 25 including the rib portions 13 and 17 is not necessary and man-hours and costs can be reduced.

The first collar 21A and the second collar 21B through which the bolt 14 for fixing the knuckle 6 passes are crimped to the collar through-hole 11r formed on the plate member 25 and the inner plate 26 at the same time as heat-crimping. Therefore, the step dedicated for only crimping the collar can be omitted and the man-hours of the trailing arm 5 can be reduced.

The rubber bush 12 for connecting the trailing arm 5 to the vehicle body 1 is simultaneously inserted into the vehicle body side connection portion 11s, which is formed by the inner plate 26 and the one-side edge portion 13c formed on the inner plate 26 at a time of injection-molding the rib portions 13 and 17, during the heat-crimping or the injection-molding. Therefore, a dedicated bush insertion process does not need to be provided and the man-hours for the trailing arm 5 can be reduced.

The plate member 25 is press-molded by a fiber reinforced resin containing reinforcing fibers. Therefore, the rigidity of the plate member 25 can be improved, the bead shape for improving the rigidity can be minimized, and the cost can be reduced by simplifying the mold.

At the time of the injection-molding, the one-side edge portion 13c is formed by the injected resin and the rubber bush 12 is crimped to the one-side edge portion 13c. Therefore, the rubber bush 12 can be crimped at the time of injection-molding the rib portions 13 and 17 and a dedicated step for crimping the bush is not necessary.

Additionally, the present invention is not limited to the above-described embodiment. For example, in this embodiment, the pair of left and right plate members 25 is provided, but at least two plate members 25 may be provided. The trailing arm manufacturing method of the above-described embodiment is applicable to three-wheeled and four-wheeled vehicles. Then, the configuration in the above-described embodiment is an example of the present invention, and various changes can be made without departing from the scope of the present invention, such as replacing the constituent elements of the embodiment with well-known constituent elements.

What is claimed is:

1. A trailing arm manufacturing method for manufacturing a trailing arm connecting a vehicle body and a knuckle supporting a vehicle wheel, the trailing arm manufacturing method comprising:
preparing a metallic inner portion and a resinous outer portion composed of at least two components;
heat-crimping the inner portion while sandwiching the inner portion with the outer portions in a state in which the inner portion is disposed between the outer portions by using a pair of molding dies including an injection-molding portion for injection-molding a rib portion having a plurality of ribs; and
injection-molding the rib portion on the outer portion during the heat-crimping or after the heat-crimping.

2. The trailing arm manufacturing method according to claim 1,
wherein a collar through which a bolt for fixing the knuckle passes is simultaneously crimped to through-holes formed in the inner portion and the outer portion during the heat-crimping.

3. The trailing arm manufacturing method according to claim 1,
wherein a bush for connecting the trailing arm to the vehicle body is simultaneously inserted into a vehicle body side connection portion during the heat-crimping or the injection-molding, the vehicle body side connection portion being formed by the inner portion and a bush fixing resin portion formed on the inner portion at a time of injection-molding the rib portion.

4. The trailing arm manufacturing method according to claim 1,
wherein the outer portion is press-molded by a fiber reinforced resin containing reinforcing fibers.

5. The trailing arm manufacturing method according to claim 3,
wherein during the injection-molding, the bush fixing resin portion is formed by injected resin and the bush is crimped to the bush fixing resin portion.
